(19) United States
(12) Patent Application Publication
(10) Pub. No.: US 2020/0208447 A1
(43) Pub. Date: Jul. 2, 2020

(54) PORTABLE STOPPER APPARATUS FOR DOOR

(71) Applicant: Abraham Farkas, Pembroke Pines, FL (US)

(72) Inventor: Abraham Farkas, Pembroke Pines, FL (US)

(21) Appl. No.: 16/236,409

(22) Filed: Dec. 29, 2018

(51) Int. Cl. E05C 17/54; E05C 17/00

(52) U.S. Cl. CPC E05C 17/54; E05Y 2900/132; E05C 17/025

(57) ABSTRACT

A portable stopper apparatus selectively attachable to a swinging door to releasably fix the door in an open position. The portable stopper apparatus may be positioned against a door that is open and desired to be mechanically held open in a space between the door and the door jamb and operates by preventing the space created by the door being opened from closing. The portable stopper apparatus is formed as a one piece structure that includes a planar portion, a bent portion that has a vertical extension panel, a horizontal extension panel, and a stopper panel positioned on three discrete planes, and a secondary member positioned between the vertical extension panel and the stopper panel.

### BACKGROUND OF THE INVENTION

### Field of the Invention

This invention relates generally to doorstops and, more particularly, to a portable stopper apparatus selectively attachable to a door and operative to releasably fix a swinging door in an open position.

### Description of the Prior Art

The use and design of various types of conventional doorstops (or door stopper) to temporarily hold a door in an open position is well established. Indeed, a conventional doorstop may be embodied as a removable structure (such as a heavy object or a wedge), a door attached structure (such as a flip down stopper), or dual component piece with a door mounted structure and a corresponding wall mounted structure (such as a magnetic stopping mechanism).

A key benefit to removable doorstops is that they are portable and can be carried by a user and selectively deployed when desired. For example, while first responders entering a building can easily carry with them portable doorstops to prop open doors as needed in an emergency situation; they clearly could not install door attached doorstops or door/wall component doorstops in such a circumstance. That said, the design and use of conventional portable doorstops still create problems for a user and/or the door being stopped. For instance, a heavy object which can prevent a door from closing may be portable in the sense that it is not fixed to the door or the area around the door, but it is still extremely heavy (by design) and not easy to carry around. In addition, it can be a tripping hazard because of how far it may extend away from the door into the opening created by the door. And with conventional wedge style doorstops, the detrimental effect that the door being jammed upwards onto such a doorstop has on the hinges of the door is well known.

In light of the issues created by conventional portable doorstop designs, there remains a need for a reasonably portable stopper apparatus that can be selectively attachable to a swinging door in a manner that releasably secures the door in an open position without damaging the structural components of the door. It would be further helpful if such a portable stopper apparatus was structured to provide both a primary and secondary stopping elements to provide a redundancy to enhance functionality and safety. It would additionally be desirable for such a portable stopper apparatus to include a plurality of attachment mechanisms to reduce the chance that the portable stopper apparatus could be inadvertently dislodged if the door being held open is contacted as people or items pass through it.

### SUMMARY OF THE INVENTION

The present disclosure provides for a portable stopper apparatus selectively attachable to a swinging door to releasably fix the door in an open position, comprising: a body having a distal end and a proximal surface and which includes a planar portion connected at one end to a bent portion; wherein said planar portion is defined by a panel which forms, at an end opposite the end where the planar portion is connected to the bent portion, the distal end; wherein said bent portion is defined by a continuous structure having at least an interconnected vertical extension panel, a horizontal extension panel, and a stopper panel; wherein said stopper panel includes the proximal surface and the proximal surface is situated on a discrete plane that intersects the plane on which said planar portion is situated; and wherein said planar portion and vertical extension panel are configured to be fixed to a swinging door and said stopper panel, when said planar portion and vertical extension panel are fixed to a door, is configured to hold the door in a fixed position.

Embodiments of the portable stopper apparatus may also include a secondary member positioned inside the bent member that operates to prevent the stopper panel from moving beyond a predetermined threshold.

### BRIEF DESCRIPTION OF THE DRAWINGS

FIG. 1 is a side perspective view of a portable stopper apparatus built in accordance with a reversible embodiment of the present invention.

FIG. 2 is a bottom plan view of a portable stopper apparatus built in accordance with a reversible embodiment of the present invention.

FIG. 3 is a top perspective view of a portable stopper apparatus built in accordance with a reversible embodiment of the present invention in place on an open door at the jamb from the direction to which the door closes.

FIG. 4 is a bottom perspective view of a portable stopper apparatus built in accordance with a reversible embodiment of the present invention in place on an open door at the jamb from the direction to which the door closes.

FIG. 5 is a side elevational view of a portable stopper apparatus built in accordance with a reversible embodiment of the present invention in place on an open door at the jamb from the direction to which the door closes.

FIG. 6 is a side elevational view of a portable stopper apparatus built in accordance with a single side embodiment of the present invention.

FIG. 7 is a bottom perspective view of a portable stopper apparatus built in accordance with a single side embodiment of the present invention.

### DETAILED DESCRIPTION OF THE INVENTION

Described herein is a portable stopper apparatus selectively attachable to a swinging door to releasably fix the door in an open position. The portable stopper apparatus may be positioned against a door that is open and desired to be mechanically held open in a space between the door and the door jamb and operates by preventing the space created by the door being opened from closing.

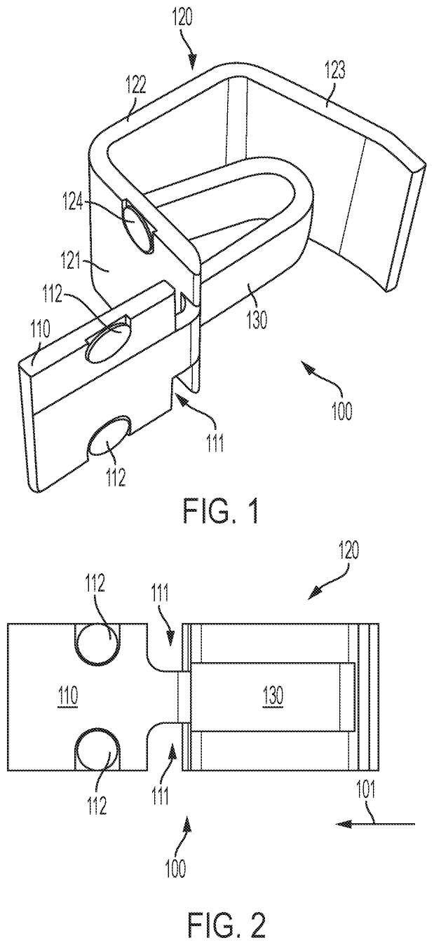

Referring now to the drawings and, in particular, FIGS. 1, 2, 3, 4, and 5, a portable stopper apparatus 100 built in accordance with a reversible embodiment is shown having an elongated one piece body that includes a planar portion 110, a bent portion 120, and a secondary member 130. The body of the portable stopper apparatus 100 may be constructed of a hard plastic, such as polyamide nylon, high-density polyethylene, polypropylene, or other substantially rigid material that retains some elasticity. In some embodiments, the body of the portable stopper apparatus 100 may alternatively be constructed of a rigid material.

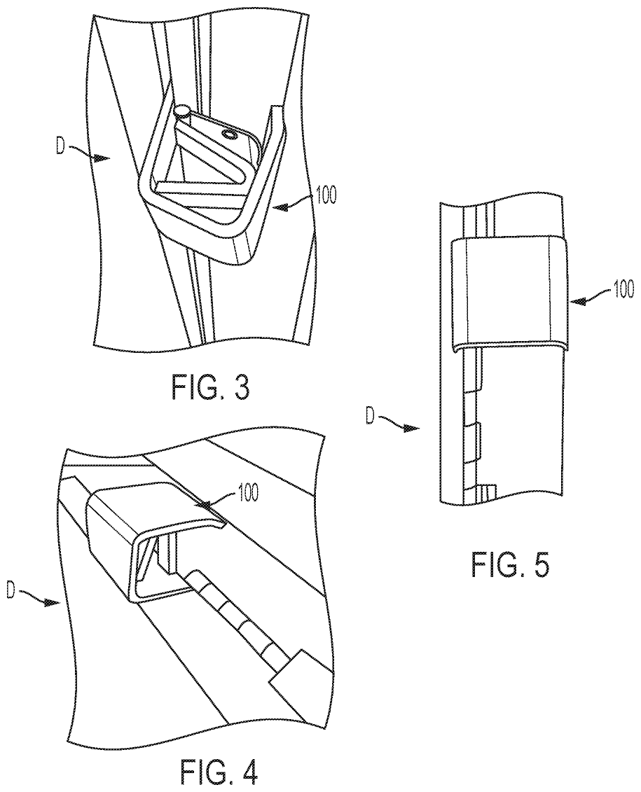

The planar portion 110 is defined by a substantially flat panel which forms at one end a distal end of the portable stopper apparatus 100. Adjacent to the opposite end of the planar portion 110 from the end which forms the distal end of the portable stopper apparatus 100 are two mirror image notches 111 which each define a recess into the longitudinal edge of the planar portion. The planar portion 110 may additionally include a pair of planar portion magnets 112 integral therewith. It is contemplated that the planar portion magnets 112 may operate to provide additional attachment force to hold the portable stopper apparatus 100 against a door D that is constructed of a ferromagnetic material when positioned in place on such a door D as shown in FIGS. 3 and 4.

The bent portion 120 may include a vertical extension panel 121, a horizontal extension panel 122, and a stopper panel 123. The vertical extension panel 121 extends from the end of the planar portion 110 opposite the end of the planar portion which forms the distal end of the portable stopper apparatus 100. The vertical extension panel 121 may be oriented at a ninety degree angle, or an angle slightly less than or greater than ninety degrees (for example, between seventy-five degrees and one-hundred and five degrees), relative to the planar portion 110.

The vertical extension panel 121 may additionally include a pair extension panel magnets 124 integral therewith, positioned to face towards the distal end of the portable stopper apparatus 100 on opposing lateral edges of the vertical extension panel 121. As with the planar portion magnets 112, the extension panel magnets 124 may operate to provide additional attachment force to hold the portable stopper apparatus 100 against a door D that is constructed of a ferromagnetic material when positioned in place on such a door D as shown in FIGS. 3 and 4.

Connected to the end of the vertical extension panel 121 opposite where the vertical extension panel 121 connects to the planar portion 110 is the horizontal extension panel 122. The horizontal extension panel 122 extends from the vertical extension panel 121 in a direction away from the distal end of the portable stopper apparatus 100 and may be oriented at a ninety degree angle, or an angle slightly greater than ninety degrees, relative to the vertical extension panel 121. In this regard, the horizontal extension panel 122 may be on a parallel plane relative to the planar portion 110.

Connected to the end of the horizontal extension panel 122 opposite where the horizontal extension panel 122 connects to the vertical extension panel 121 is the stopper panel 123. The stopper panel 123 extends from the horizontal extension panel 122 in a direction towards the extended plane on which the planar portion 110 is situated, and may be oriented at an angle slightly greater than ninety degrees, relative to the horizontal extension panel 122. In this regard, the vertical extension panel 121, horizontal extension panel 122, and stopper panel 123 may form a shape similar to a “U,” but the substantially flat horizontal extension panel 122 forming the bottom.

The surface of the stopper panel 123 which faces away from the vertical extension panel 121 forms a proximal end of the portable stopper apparatus 100.

The secondary member 130 may be defined as an arch which extends from a surface of the vertical extension panel 121 that faces the stopper panel 123 towards the stopper panel 123. The apex of the secondary member 130 operates to provide the secondary stopping structure in the event the stopper panel 123 bends due to pressure from a door D in a closing direction 101. In this regard, the secondary member 130 prevents the stopper panel 123 from moving beyond a predetermined threshold, namely the apex of the secondary member 130. It is contemplated, however, that the secondary member 130 may define an alternate shape, with the portion of the secondary member 130 closest to the stopper panel 123 operating to provide the secondary stopping structure in the event the stopper panel 123 bends due to pressure from a door D in a closing direction 101.

It is contemplated that the use of the secondary member 130 in addition to the stopper panel 123 not only provides redundancy and thus increases safety, it allows for the use of materials that have some elasticity to form the portable stopper apparatus 100, which also can provide for enhanced durability.

As illustrated in FIGS. 3 and 4, when the portable stopper apparatus 100 is in place on an opened door D, the portable stopper apparatus 100 may be positioned in the door jamb with one of the hinges of the door D sliding into one of the notches 111 and the stopper panel 123 placed against the surface of the door D. In this regard, the planar portion 110 and the vertical extension panel 121 operate to hold the portable stopper apparatus 100 on the door D at the door jamb, the stopper panel 123 against the surface of the door, and the horizontal extension panel 122 spacing the stopper panel 123 away from the planar portion 110 and the vertical extension panel 121 so as to cause the stopper panel 123 to prevent the door from closing.

It is appreciated that by having notches 111 on either lateral side of the portable stopper apparatus 100, the portable stopper apparatus 100 can be positioned on doors that open to in either direction by simply flipping the portable stopper apparatus 100 over.

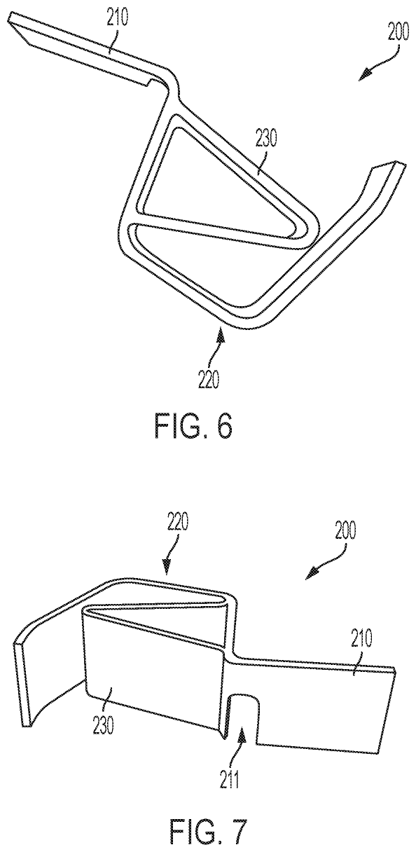

Referring now to FIGS. 6 and 7, a portable stopper apparatus 200 built in accordance with a single side embodiment is structured in almost the same manner as the portable stopper apparatus built in accordance with a reversible embodiment. The portable stopper apparatus 200 also includes a planar portion 210, a bent portion 220, and a secondary member 230, with each positioned in the same relative orientation. As the planar portion 210 only includes a single notch 211, however, if it is desired to rest the portable stopper apparatus 200 on the hinge of a D, the portable stopper apparatus 200 must be oriented with the notch 211 facing downward.

It is contemplated, however, that the portable stopper apparatus 200 may be positioned in a door jamb and not slid onto a hinge as the closing force of the door is sufficient to hold the portable stopper apparatus 200 in place absent the door being pushed further open.

Further, as the closing force of the door is sufficient to hold a portable stopper apparatus in accordance with the present invention in place, it is contemplated that a portable stopper apparatus may be constructed without any notches, and with or without magnets.

It is contemplated that while the portable stopper apparatus may be formed of a one piece body in some embodiments, it may also be formed of a plurality of pieces which are attached together. For example, in an embodiment, the horizontal extension panel and stopper panel may be formed of discrete panels which are connected in a manner which allows the stopper panel to hinge.

The instant invention has been shown and described herein in what is considered to be the most practical and preferred embodiment. It is recognized, however, that departures may be made therefrom within the scope of the invention and that obvious modifications will occur to a person skilled in the art.

What is claimed is:

1. A portable stopper apparatus selectively attachable to a swinging door to releasably fix the door in an open position, comprising:
a body having a distal end and a proximal surface and which includes a planar portion connected at one end to a bent portion;
wherein said planar portion is defined by a panel which forms, at an end opposite the end where the planar portion is connected to the bent portion, the distal end;
wherein said bent portion is defined by a continuous structure having at least an interconnected vertical extension panel, a horizontal extension panel, and a stopper panel;
wherein said stopper panel includes the proximal surface and the proximal surface is situated on a discrete plane that intersects the plane on which said planar portion is situated; and
wherein said planar portion and vertical extension panel are configured to be fixed to a swinging door and said stopper panel, when said planar portion and vertical extension panel are fixed to a door, is configured to hold the door in a fixed position.

2. The portable stopper apparatus selectively attachable to a swinging door to releasably fix the door in an open position of claim 1, additionally comprising a secondary member integral with said bent portion and configured to prevent said stopper panel from moving beyond a predetermined threshold.

3. The portable stopper apparatus selectively attachable to a swinging door to releasably fix the door in an open position of claim 2, wherein said secondary member has a shape of an arch.

4. The portable stopper apparatus selectively attachable to a swinging door to releasably fix the door in an open position of claim 3, wherein said predetermined threshold beyond which said stopper panel cannot move is created the apex of said arch.

5. The portable stopper apparatus selectively attachable to a swinging door to releasably fix the door in an open position of claim 1, wherein said vertical extension panel is configured to receive and be placed over a hinge of a door.

6. The portable stopper apparatus selectively attachable to a swinging door to releasably fix the door in an open position of claim 1, wherein said vertical extension panel connects to the planar portion at one end, said horizontal extension panel connects at one end to the end of said vertical extension panel opposite to where said vertical extension panel connects to the planar portion, and said stopper panel connects at one end to the end of said horizontal extension panel opposite to where said horizontal extension panel connects to said vertical extension panel.

7. The portable stopper apparatus selectively attachable to a swinging door to releasably fix the door in an open position of claim 6, wherein said vertical extension panel is oriented at an angle of at least seventy five degrees relative to said planar portion.

8. The portable stopper apparatus selectively attachable to a swinging door to releasably fix the door in an open position of claim 6, wherein said horizontal extension panel is oriented at an angle of at least ninety degrees relative to said vertical extension panel.

9. The portable stopper apparatus selectively attachable to a swinging door to releasably fix the door in an open position of claim 8, wherein said horizontal extension panel is situated on a plane which is parallel to the plane on which said planar portion is situated.

10. The portable stopper apparatus selectively attachable to a swinging door to releasably fix the door in an open position of claim 5, wherein said stopper panel is oriented at an angle of at least ninety degrees relative to said horizontal extension panel.

11. A portable stopper apparatus selectively attachable to a swinging door to releasably fix the door in an open position, comprising:
a body having a distal end and a proximal surface and which includes a planar portion connected at one end to a bent portion;
wherein said planar portion is defined by a panel which forms, at an end opposite the end where the planar portion is connected to the bent portion, the distal end;
wherein said bent portion is defined by a continuous structure having at least an interconnected vertical extension panel, a horizontal extension panel, and a stopper panel;
wherein said vertical extension panel connects to the planar portion at one end, said horizontal extension panel connects at one end to the end of said vertical extension panel opposite to where said vertical extension panel connects to the planar portion, and said stopper panel connects at one end to the end of said horizontal extension panel opposite to where said horizontal extension panel connects to said vertical extension panel;
wherein said stopper panel includes the proximal surface and the proximal surface is situated on a discrete plane that intersects the plane on which said planar portion is situated;
wherein said planar portion and vertical extension panel are configured to be fixed to a swinging door and said stopper panel, when said planar portion and vertical extension panel are fixed to a door, is configured to hold the door in a fixed position; and
a secondary member integral with said bent portion and configured to prevent said stopper panel from moving beyond a predetermined threshold.

12. The portable stopper apparatus selectively attachable to a swinging door to releasably fix the door in an open position of claim 11, wherein said secondary member has a shape of an arch.

13. The portable stopper apparatus selectively attachable to a swinging door to releasably fix the door in an open position of claim 12, wherein said predetermined threshold beyond which said stopper panel cannot move is created the apex of said arch.

14. The portable stopper apparatus selectively attachable to a swinging door to releasably fix the door in an open position of claim 11, wherein said vertical extension panel is configured to receive and be placed over a hinge of a door.

15. The portable stopper apparatus selectively attachable to a swinging door to releasably fix the door in an open position of claim 11, wherein said vertical extension panel is oriented at an angle of at least seventy five degrees relative to said planar portion.

16. The portable stopper apparatus selectively attachable to a swinging door to releasably fix the door in an open position of claim 15, wherein said horizontal extension panel is oriented at an angle of at least ninety degrees relative to said vertical extension panel and said horizontal extension panel is situated on a plane which is parallel to the plane on which said planar portion is situated.

17. The portable stopper apparatus selectively attachable to a swinging door to releasably fix the door in an open position of claim 16, wherein said stopper panel is oriented at an angle of at least ninety degrees relative to said horizontal extension panel.

18. The portable stopper apparatus selectively attachable to a swinging door to releasably fix the door in an open position of claim 17, wherein said secondary member extends from a surface of said vertical extension panel that faces towards the proximal surface in a direction towards said stopper panel.

19. A portable stopper apparatus selectively attachable to a swinging door to releasably fix the door in an open position, comprising:
a body having a distal end and a proximal surface and which includes a planar portion connected at one end to a bent portion;
wherein said planar portion is defined by a panel which forms, at an end opposite the end where the planar portion is connected to the bent portion, the distal end; and
wherein said bent portion is defined by a continuous structure having at least a first discrete surface, a second discrete surface, and a third discrete surface, each situated on a discrete plane;
wherein said proximal surface is defined by the first discrete surface and the discrete plane on which the proximal surface is situated intersects the plane on which said planar portion is situated.

20. The portable stopper apparatus selectively attachable to a swinging door to releasably fix the door in an open position of claim 19, wherein:
the discrete plane on which the second discrete surface is situated intersects the plane on which said planar portion is situated; and
the discrete plane on which the third discrete surface is situated is parallel the plane on which said planar portion is situated.
